(19) United States
(12) Patent Application Publication
(10) Pub. No.: US 2024/0342755 A1
(43) Pub. Date: Oct. 17, 2024

(54) MULTILAYER PROTECTIVE FILMS AND METHODS OF USING SAME

(71) Applicant: Feynlab Inc., Lombard, IL (US)

(72) Inventor: John Suerth, Lombard, IL (US)

(21) Appl. No.: 18/644,486

(22) Filed: Apr. 24, 2024

Related U.S. Application Data
(60) Provisional application No. 63/489,120, filed on Mar. 8, 2023.

(51) Int. Cl. B05D 7/00; B05D 1/34

(52) U.S. Cl. CPC B05D 7/5423; B05D 1/34; B05D 2320/00; B05D 2518/10

(57) ABSTRACT

The present disclosure provides multilayer films including a first layer disposed adjacent to a painted surface, the first layer comprising, consisting essentially of, or consisting of a semi-polar polymer such as a polysilazane (PSZ), polysiloxazane or a copolymer of polysilazane and polysiloxane repeat units (e.g., a polysiloxazane); and an outer layer disposed opposite the painted surface, the outer layer comprising, consisting essentially of, or consisting of a non-polar material such as a crosslinked hydroxy-terminated polydimethylsiloxane or a crosslinked silanol-terminated polydialkylsiloxane.

### PRIORITY CLAIM

This application claims priority to U.S. Provisional Patent Application Ser. No. 63/489,120, filed on Mar. 8, 2023, the entire contents of which are incorporated herein by reference and relied upon.

### FIELD OF THE INVENTION

The present disclosure relates generally to the field of vehicle coatings, and more specifically to a ceramic coating for the exterior of vehicles that is applied to the paint only. Vehicle coatings are used to protect the exterior of vehicles from various environmental factors such as UV radiation, heat, cold, rain, and dirt. Ceramic coatings are becoming increasingly popular due to their durability, hydrophobic properties, and ability to enhance the shine and appearance of a vehicle. Films consistent with the present disclosure offer a unique approach to ceramic coatings by combining two self-assembling layers into one, which provides enhanced protection and durability compared to existing coatings in the market.

### BACKGROUND

Vehicle coatings, particularly ceramic coatings, have become increasingly popular due to their ability to protect the exterior of vehicles from various environmental factors such as UV radiation, heat, cold, rain, and dirt. However, current ceramic coatings are typically applied as a single layer, which can limit their effectiveness and durability over time. Additionally, some ceramic coatings can be difficult to apply, requiring specialized equipment and expertise.

In order to combine all the available properties, multiple layers of different coatings have to be consecutively applied, which is a time-consuming and labor-intensive process. This process involves the application of a basecoat for thickness, depth of gloss, and durability, followed by a topcoat to enhance the gloss and hydrophobic properties. These additional steps increase the application time and complexity, as well as the cost to the end user.

The inventors are not aware of any existing ceramic vehicle coatings that offer multiple layers of sufficiently durable protection from application of a single composition. Therefore, there remains a need for a more efficient and effective ceramic coating that can combine all the desired properties in a single layer. Such a coating would provide enhanced protection and durability, while also being easy to apply and maintain. This would result in significant benefits to vehicle owners, including reduced maintenance time and costs, improved protection and appearance, and increased customer satisfaction.

### SUMMARY

The present disclosure provides novel ceramic coatings for the exterior of vehicles that is applied to the paint with a single application. Coatings consistent with the present disclosure are unique at least in that they form two distinct self-assembled layers from just one application, providing enhanced protection and durability compared to existing coatings on the market. The first layer comprises, consists essentially of, or consists of a semi-polar polymer that provides thickness, depth of gloss, and durability to the coating. The outer layer is disposed opposite the painted surface and comprises, consists essentially of, or consists of a non-polar material that enhances the gloss and hydrophobic properties of the coating.

The two distinct layers adhere better to each other than traditional coatings, reducing the risk of delamination, and the simplified application process makes it more accessible to a wider range of users. The invention offers significant time and labor savings when professionally installed, as the two layers are formed with just one application. This reduces the amount of time and labor required for the installation process, making it more cost-effective for both the installer and the end user. Additionally, the coating is easy to apply and maintain, making it an attractive option for vehicle owners looking for a high-performance coating that is both durable and easy to maintain. Overall, this invention offers a unique and efficient solution to the limitations of current ceramic coatings, and its distinctiveness lies in the combination of two self-assembly layers into one with a single application, comprising a first layer of a semi-polar polymer and an outer layer of a non-polar material.

In some embodiments, the present disclosure provides a protective film comprising a first layer disposed adjacent to a painted surface, the first layer comprising, consisting essentially of, or consisting of a semi-polar polymer; and an outer layer disposed opposite the painted surface, the outer layer comprising, consisting essentially of, or consisting of a non-polar material.

In some embodiments, the present disclosure provides a method of forming a paint protective layer on a substrate, the method comprising applying a first layer to the substrate, the first layer comprising, consisting essentially of, or consisting of a semi-polar polymer; and an outer layer disposed opposite the painted surface, the top layer comprising, consisting essentially of, or consisting of a non-polar material.

### BRIEF DESCRIPTION OF THE FIGURES

FIG. 1 shows a representative cross section of a film (e.g., a multilayer film) consistent with the present disclosure after being applied to a substrate and including an outer layer and a semi-polar layer disposed between the substrate and the outer layer.

FIG. 2 shows a representative cross section of a film (e.g., a multilayer film) consistent with the present disclosure after being applied to a substrate and including an optional coupling layer disposed between the semi-polar layer and the non-polar layer, after being applied to a substrate.

FIG. 3 shows a representative cross section of a film (e.g., a multilayer film) consistent with the present disclosure after being applied to a substrate and including an optional coupling layer disposed between the semi-polar layer and the non-polar layer, and an optional nanoparticle layer disposed between the substrate and the semi-polar layer.

### DETAILED DESCRIPTION

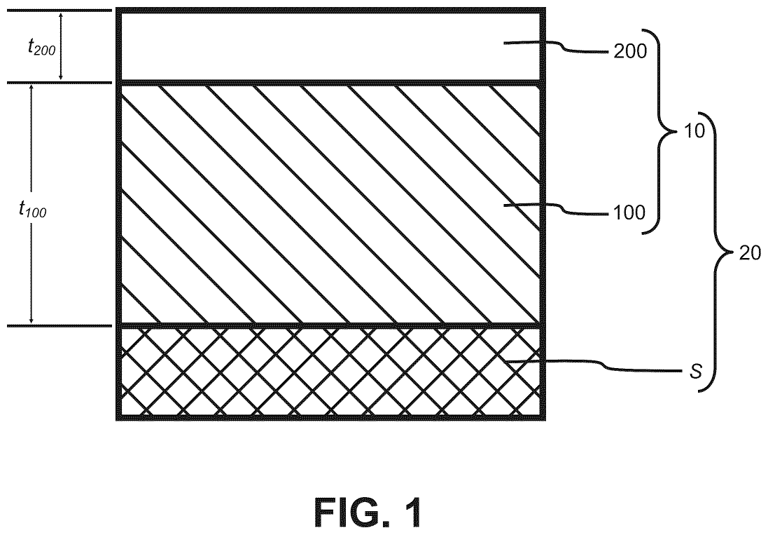

Referring generally to FIGS. 1-3, the present disclosure provides films (e.g., multi-layer films) for protecting painted surfaces S, such as painted automobile panels, and methods of making and using same. In some embodiments, the multi-layer film is applied in a single step (e.g., the multi-layer films self-assemble after a single composition comprising the polymers that form each layer of the film 10, or their monomeric precursors, is applied to the substrate S.

### Film Compositions

Generally, films 10 consistent with the present disclosure include a first semi-polar layer 100 and a second non-polar layer 200 disposed on a substrate S. The substrate S may be any surface for which protection might be desired, such as a painted surface like a painted automobile panel.

Films 10 consistent with the present disclosure generally have a gloss value at 60° (XQT 104 method) of at least about 80 GU, for example at least about 80 GU, at least about 81 GU, at least about 82 GU, at least about 83 GU, at least about 84 GU, at least about 85 GU, at least about 86 GU, at least about 87 GU, at least about 88 GU, at least about 89 GU, at least about 90 GU, at least about 91 GU, at least about 92 GU, at least about 93 GU, at least about 94 GU, or at least about 95 GU.

Films 10 consistent with the present disclosure generally have a UV resistance value after 1,000 hours of exposure (ASTM D4329 method) of at least about 80%, for example at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%.

Films 10 consistent with the present disclosure generally have a total thickness (t₁₀₀+t₂₀₀+t₃₀₀) of about 2 microns to about 15 microns, or about 3 microns to about 12 microns, or about 5 microns to about 10 microns.

### A. Semi-Polar Layer

The semi-polar layer 100 is disposed adjacent to (e.g., in contact with) a substrate S. Generally, the semi-polar layer 100 permanently adheres to the substrate S. In some embodiments, the semi-polar layer 100 temporarily (e.g., semi-permanently) adheres to the substrate S (e.g., to an outermost surface, paint or coating layer of the substrate S).

The first layer 100 includes a semi-polar polymer. The term “semi-polar” as used herein refers generally to the surface properties of the first layer 100, and indicates that the exposed surface of the semi-polar layer 100 is relatively more polar (e.g., the water contact angle of the exposed surface of a semi-polar layer 100 is relatively lower than the water contact angle of the exposed surface of a non-polar layer 200). In some embodiments, the external surface of the semi-polar layer 100 has a contact angle of about 90° to about 110° as measured by ASTM <D7334-08> (2014), such as about 90°, about 91°, about 92°, about 93°, about 94°, about 95°, about 96°, about 97°, about 98°, about 99°, about 100°, about 101°, about 102°, about 103°, about 104°, about 105°, about 106°, about 107°, about 108°, about 109°, or about 110°. In some embodiments, the semi-polar layer 100 comprises a semi-polar polymer. In some embodiments, the semi-polar layer 100 consists essentially of a semi-polar polymer. In some embodiments, the semi-polar layer 100 consists of a semi-polar polymer.

The semi-polar polymer may, in some embodiments, comprise, consist essentially of, or consist of a polymer, a copolymer or block copolymer.

In some embodiments, the semi-polar polymer comprises, consists essentially of, or consists of a polysilazane (PSZ), a polysiloxane, or a copolymer of polysilazane and polysiloxane repeat units (e.g., a polysiloxazane).

In some embodiments, the semi-polar polymer comprises, consists essentially of, or consists of a PSZ having a formula consistent with general formula (I):

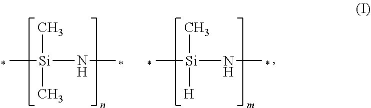

wherein:
m is 0.5 to 0.9,
n is 0.1 to 0.5, and
m+n=1.

In some embodiments, the monomethylsilazane repeat unit is present in an amount of about 0.5 to 0.9 (i.e., m is 0.5 to 0.9), or about 0.6 to 0.8 (i.e., m is 0.6 to 0.8), or about 0.6 to 0.7 (i.e., m is 0.6 to 0.7), such as 0.5, about 0.51, about 0.52, about 0.53, about 0.54, about 0.55, about 0.56, about 0.57, about 0.58, about 0.59, about 0.6, about 0.61, about 0.62, about 0.63, about 0.64, about 0.65, about 0.66, about 0.67, about 0.68, about 0.69, about 0.7, about 0.71, about 0.72, about 0.73, about 0.74, about 0.75, about 0.76, about 0.77, about 0.78, about 0.79, about 0.8, about 0.81, about 0.82, about 0.83, about 0.84, about 0.85, about 0.86, about 0.87, about 0.88, about 0.89, or about 0.9.

In some embodiments, the dimethylsilazane repeat unit is present in an amount of about 0.1 to 0.5 (i.e., n is 0.1 to 0.5), or about 0.2 to 0.4 (i.e., n is 0.2 to 0.4), or about 0.25 to 0.4 (i.e., n is 0.25 to 0.4), such as 0.1, about 0.11, about 0.12, about 0.13, about 0.14, about 0.15, about 0.16, about 0.17, about 0.18, about 0.19, about 0.2, about 0.21, about 0.22, about 0.23, about 0.24, about 0.25, about 0.26, about 0.27, about 0.28, about 0.29, about 0.3, about 0.31, about 0.32, about 0.33, about 0.34, about 0.35, about 0.36, about 0.37, about 0.38, about 0.39, about 0.4, about 0.41, about 0.42, about 0.43, about 0.44, about 0.45, about 0.46, about 0.47, about 0.48, about 0.49, or about 0.5.

In some embodiments, the ratio of n to m in a PSZ consistent with general formula (I) is about 1:4 to about 1:1, or about 1:3 to about 1:2, for example about 1:4, about 1:3.9, about 1:3.8, about 1:3.7, about 1:3.6, about 1:3.5, about 1:3.4, about 1:3.3, about 1:3.2, about 1:3.1, about 1:3, about 1:2.9, about 1:2.8, about 1:2.7, about 1:2.6, about 1:2.5, about 1:2.4, about 1:2.3, about 1:2.2, about 1:2.1, about 1:2, about 1:1.9, about 1:1.8, about 1:1.7, about 1:1.6, about 1:1.5, about 1:1.4, about 1:1.3, about 1:1.2, about 1:1.1, or about 1:1.

In some embodiments, the PSZ having a formula consistent with general formula (I) has an average molecular weight of about 2,000 g/mol to about 3,000 g/mol, for example about 2,000 g/mol, about 2,050 g/mol, about 2,100 g/mol, about 2,150 g/mol, about 2,200 g/mol, about 2,250 g/mol, about 2,300 g/mol, about 2,350 g/mol, about 2,400 g/mol, about 2,450 g/mol, about 2,500 g/mol, about 2,550 g/mol, about 2,600 g/mol, about 2,650 g/mol, about 2,700 g/mol, about 2,750 g/mol, about 2,800 g/mol, about 2,850 g/mol, about 2,900 g/mol, about 2,950 g/mol, or about 3,000 g/mol.

In some embodiments, the semi-polar polymer comprises, consists essentially of, or consists of a PSZ having a formula consistent with general formula (II):

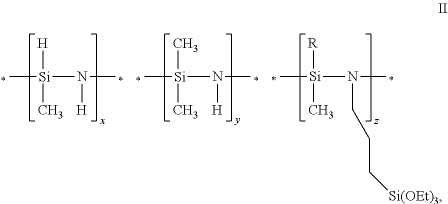

wherein:
x is 0.45 to 0.59,
y is 0.22 to 0.29,
z is 0.12 to 0.33,
x+y+Z=1, and
R is H or CH₃.

In some embodiments, the monomethylsilazane repeat unit is present in an amount of about 0.45 to about 0.59 (i.e., x is about 0.45 to about 0.59), or about 0.50 to about 0.55 (i.e., x is about 0.50 to about 0.55), for example about 0.45, about 0.46, about 0.47, about 0.48, about 0.49, about 0.5, about 0.51, about 0.52, about 0.53, about 0.54, about 0.55, about 0.56, about 0.57, about 0.58, or about 0.59.

In some embodiments, the dimethylsilazane repeat unit is present in an amount of about 0.22 to about 0.29 (i.e., y is about 0.22 to about 0.29), or about 0.24 to about 0.27 (i.e., y is about 0.24 to about 0.27), for example about 0.22, about 0.23, about 0.24, about 0.25, about 0.26, about 0.27, about 0.28, or about 0.29.

In some embodiments, the R-substituted N-[(triethoxysilyl)propanyl]-methylsilazane repeat unit is present in an amount of about 0.12 to about 0.33 (i.e., z is about 0.12 to about 0.33), or about 0.15 to about 0.3 (i.e., z is about 0.15 to about 0.3), or about 0.2 to about 0.25 (i.e., z is about 0.2 to about 0.25), for example about 0.12, about 0.13, about 0.14, about 0.15, about 0.16, about 0.17, about 0.18, about 0.19, about 0.2, about 0.21, about 0.22, about 0.23, about 0.24, about 0.25, about 0.26, about 0.27, about 0.28, about 0.29, about 0.3, about 0.31, about 0.32, or about 0.33.

The R group of the R-substituted N-[(triethoxysilyl)propanyl]methylsilazane repeat unit may be hydrogen or methyl. In some embodiments, R is hydrogen. In other embodiments, R is methyl.

In some embodiments, the PSZ includes both N-[(triethoxysilyl)propanyl]-methylsilazane repeat units (i.e., R is H) and N-[(triethoxysilyl)propanyl]dimethylsilazane repeat units (i.e., R is methyl). In such embodiments, the ratio of N-[(triethoxysilyl)propanyl]methylsilazane repeat units (i.e., R is H) to N-[(triethoxysilyl)-propanyl]dimethylsilazane repeat units (i.e., R is methyl) may be from about 1:99 to about 99:1, for example about 1:99, about 2:98, about 3:97, about 4:96, about 5:95, about 6:94, about 7:93, about 8:92, about 9:91, about 10:90, about 11:89, about 12:88, about 13:87, about 14:86, about 15:85, about 16:84, about 17:83, about 18:82, about 19:81, about 20:80, about 21:79, about 22:78, about 23:77, about 24:76, about 25:75, about 26:74, about 27:73, about 28:72, about 29:71, about 30:70, about 31:69, about 32:68, about 33:67, about 34:66, about 35:65, about 36:64, about 37:63, about 38:62, about 39:61, about 40:60, about 41:59, about 42:58, about 43:57, about 44:56, about 45:55, about 46:54, about 47:53, about 48:52, about 49:51, about 50:50, about 51:49, about 52:48, about 53:47, about 54:46, about 55:45, about 56:44, about 57:43, about 58:42, about 59:41, about 60:40, about 61:39, about 62:38, about 63:37, about 64:36, about 65:35, about 66:34, about 67:33, about 68:32, about 69:31, about 70:30, about 71:29, about 72:28, about 73:27, about 74:26, about 75:25, about 76:24, about 77:23, about 78:22, about 79:21, about 80:20, about 81:19, about 82:18, about 83:17, about 84:16, about 85:15, about 86:14, about 87:13, about 88:12, about 89:11, about 90:10, about 91:9, about 92:8, about 93:7, about 94:6, about 95:5, about 96:4, about 97:3, about 98:2, or about 99:1.

In some embodiments, x is about 0.5, y is about 0.25, and z is about 0.25.

In some embodiments, the PSZ having a formula consistent with general formula (II) has an average molecular weight of about 2,000 g/mol to about 3,000 g/mol, for example about 2,000 g/mol, about 2,050 g/mol, about 2,100 g/mol, about 2,150 g/mol, about 2,200 g/mol, about 2,250 g/mol, about 2,300 g/mol, about 2,350 g/mol, about 2,400 g/mol, about 2,450 g/mol, about 2,500 g/mol, about 2,550 g/mol, about 2,600 g/mol, about 2,650 g/mol, about 2,700 g/mol, about 2,750 g/mol, about 2,800 g/mol, about 2,850 g/mol, about 2,900 g/mol, about 2,950 g/mol, or about 3,000 g/mol.

In some embodiments, the semi-polar polymer comprises, consists essentially of, or consists of a PSZ having a formula consistent with general formula (III):

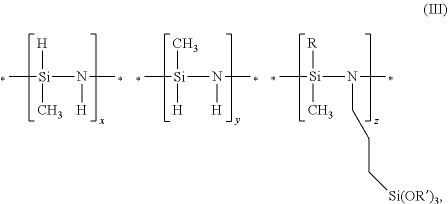

wherein:
x is 0.3 to 0.7,
y is 0.1 to 0.4,
z is 0.05 to 0.5,
x+y+Z=1,
R is H, Me, Et, n-Pr, i-Pr, n-Bu, i-Bu, sec-Bu, or t-Bu, and
R′ is Me, Et, n-Pr, i-Pr, n-Bu, i-Bu, sec-Bu, or t-Bu.

In some embodiments, the monomethylsilazane repeat unit is present in an amount of about 0.3 to about 0.7 (i.e., x is about 0.3 to about 0.7), about 0.4 to about 0.6 (i.e., x is about 0.4 to about 0.6), or about 0.45 to about 0.55 (i.e., x is about 0.45 to about 0.55), for example about 0.3, about 0.31, about 0.32, about 0.33, about 0.34, about 0.35, about 0.36, about 0.37, about 0.38, about 0.39, about 0.4, about 0.41, about 0.42, about 0.43, about 0.44, about 0.45, about 0.46, about 0.47, about 0.48, about 0.49, about 0.5, about 0.51, about 0.52, about 0.53, about 0.54, about 0.55, about 0.56, about 0.57, about 0.58, about 0.59, about 0.6, about 0.61, about 0.62, about 0.63, about 0.64, about 0.65, about 0.66, about 0.67, about 0.68, about 0.69, or about 0.7.

In some embodiments, the dimethylsilazane repeat unit is present in an amount of about 0.1 to about 0.4 (i.e., y is about 0.1 to about 0.4), or about 0.15 to about 0.35 (i.e., y is about 0.15 to about 0.35), or about 0.2 to about 0.3 (i.e., y is about 0.2 to about 0.3), for example about 0.1, about 0.11, about 0.12, about 0.13, about 0.14, about 0.15, about 0.16, about 0.17, about 0.18, about 0.19, about 0.2, about 0.21, about 0.22, about 0.23, about 0.24, about 0.25, about 0.26, about 0.27, about 0.28, about 0.29, about 0.3, about 0.31, about 0.32, about 0.33, about 0.34, about 0.35, about 0.36, about 0.37, about 0.38, about 0.39, or about 0.4.

In some embodiments, the R-substituted N-[(trialkoxysilyl)propanyl]-methylsilazane repeat unit is present in an amount of about 0.05 to about 0.5 (i.e., z is about 0.05 to about 0.5), or about 0.15 to about 0.4 (i.e., z is about 0.15 to about 0.4), or about 0.2 to about 0.3 (i.e., z is about 0.2 to about 0.3), for example about 0.05, about 0.06, about 0.07, about 0.08, about 0.09, about 0.1, about 0.11, about 0.12, about 0.13, about 0.14, about 0.15, about 0.16, about 0.17, about 0.18, about 0.19, about 0.2, about 0.21, about 0.22, about 0.23, about 0.24, about 0.25, about 0.26, about 0.27, about 0.28, about 0.29, about 0.3, about 0.31, about 0.32, about 0.33, about 0.34, about 0.35, about 0.36, about 0.37, about 0.38, about 0.39, about 0.4, about 0.41, about 0.42, about 0.43, about 0.44, about 0.45, about 0.46, about 0.47, about 0.48, about 0.49, or about 0.5.

In some embodiments, the R group of the R-substituted N-[(trialkoxysilyl)propanyl]methylsilazane repeat unit is selected from the group consisting of: hydrogen, methyl, ethyl, n-propyl, isopropyl, n-butyl, isobutyl, sec-butyl, and t-butyl. In some embodiments, R is hydrogen. In other embodiments, R is methyl. In other embodiments, R is ethyl. In other embodiments, R is n-propyl. In other embodiments, R is ispropyl. In other embodiments, R is n-butyl. In other embodiments, R is isobutyl. In other embodiments, R is sec-butyl. In other embodiments, R is t-butyl.

In some embodiments, R is more than one of hydrogen, methyl, ethyl, n-propyl, isopropyl, n-butyl, isobutyl, sec-butyl, and t-butyl.

In some embodiments, the R′ group of the R-substituted N-[(trialkoxysilyl)propanyl]methylsilazane repeat unit is selected from the group consisting of: methyl, ethyl, n-propyl, isopropyl, n-butyl, isobutyl, sec-butyl, and t-butyl. In other embodiments, R′ is methyl. In other embodiments, R′ is ethyl. In other embodiments, R′ is n-propyl. In other embodiments, R′ is ispropyl. In other embodiments, R′ is n-butyl. In other embodiments, R′ is isobutyl. In other embodiments, R′ is sec-butyl. In other embodiments, R′ is t-butyl.

In some embodiments, R and R′ are selected to provide the R-substituted N-[(trialkoxysilyl)propanyl]methylsilazane repeat unit shown in Table 1 below:

TABLE 1
Selected R-substituted N-[(trialkoxysilyl)propanyl]methylsilazane
Repeat Units

| R | R′ | Repeat unit structure | Formula |
|---|---|---|---|
| H | Methyl | 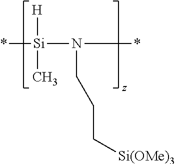 | (IVa) |
| H | Ethyl | 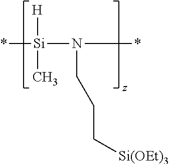 | (IVb) |
| H | n-Propyl | 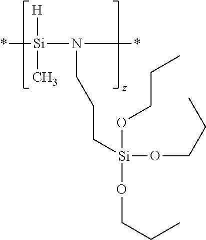 | (IVe) |
| H | Isopropyl | 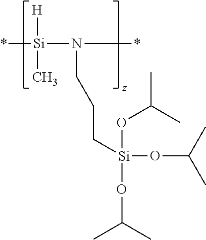 | (IVf) |
| H | n-Butyl | 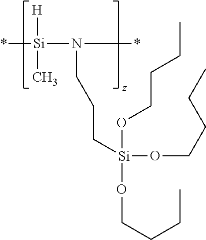 | (IVg) |
| H | Isobutyl | 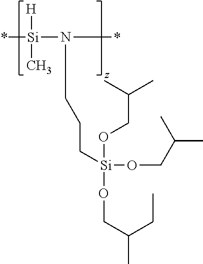 | (IVh) |
| H | sec-Butyl | 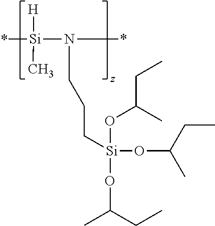 | (IVj) |
| H | t-Butyl | 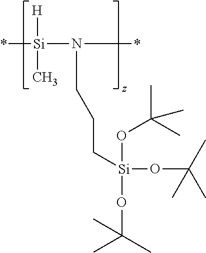 | (IVk) |
| Methyl | Methyl | 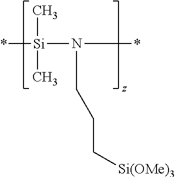 | (IVn) |
| Methyl | Ethyl | 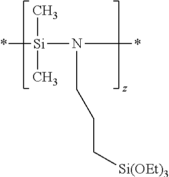 | (IVo) |
| Methyl | n-Propyl | 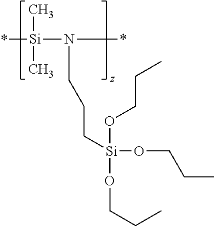 | (IVp) |
| Methyl | Isopropyl | 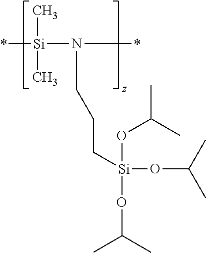 | (IVq) |
| Methyl | n-Butyl | 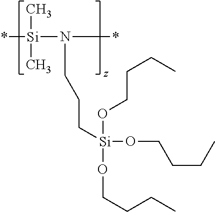 | (IVr) |
| Methyl | Isobutyl | 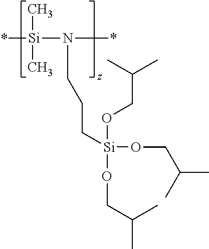 | (IVs) |
| Methyl | sec-Butyl | 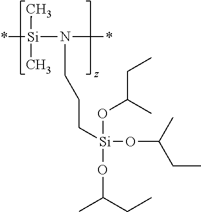 | (IVt) |
| Methyl | t-Butyl | 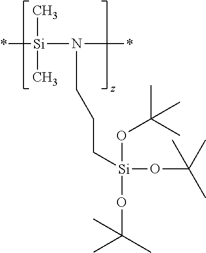 | (IVu) |
| Ethyl | Methyl | 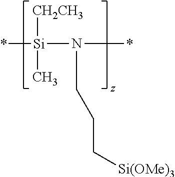 | (IVw) |
| Ethyl | Ethyl | 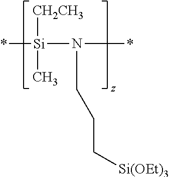 | (IVy) |
| Ethyl | n-Propyl | 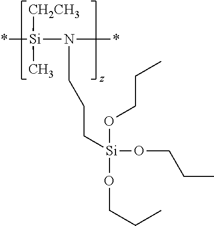 | (IVz) |
| Ethyl | Isopropyl | 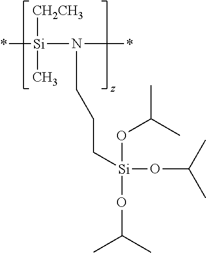 | (IVaa) |
| Ethyl | n-Butyl | 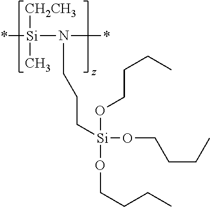 | (IVbb) |
| Ethyl | Isobutyl | 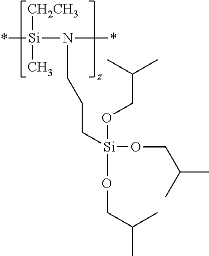 | (IVee) |
| Ethyl | sec-Butyl | 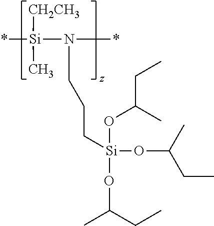 | (IVff) |
| Ethyl | t-Butyl | 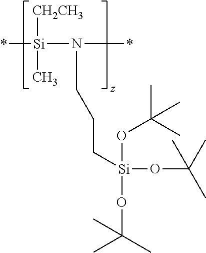 | (IVgg) |
| n-Propyl | Methyl | 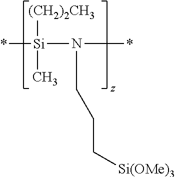 | (IVhh) |
| n-Propyl | Ethyl | 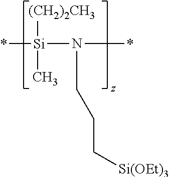 | (IVjj) |
| n-Propyl | n-Propyl | 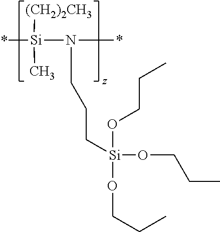 | (IVkk) |
| n-Propyl | Isopropyl | 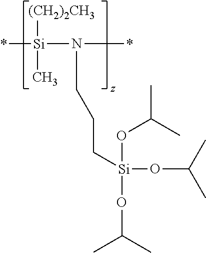 | (IVnn) |
| n-Propyl | n-Butyl | 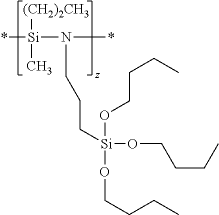 | (IVoo) |
| n-Propyl | Isobutyl | 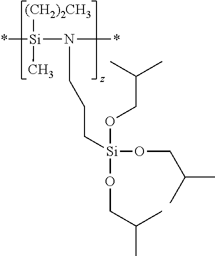 | (IVpp) |
| n-Propyl | sec-Butyl | 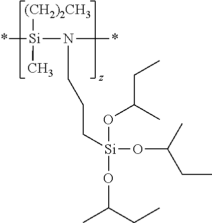 | (IVqq) |
| n-Propyl | t-Butyl | 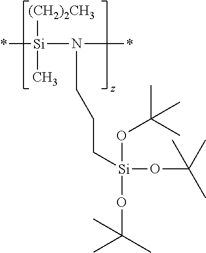 | (IVrr) |
| Isopropyl | Methyl | 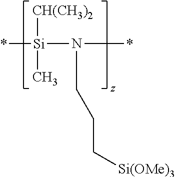 | (IVss) |
| Isopropyl | Ethyl | 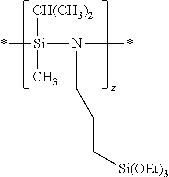 | (IVtt) |
| Isopropyl | n-Propyl | 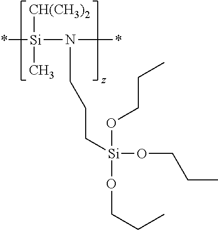 | (IVuu) |
| Isopropyl | Isopropyl | 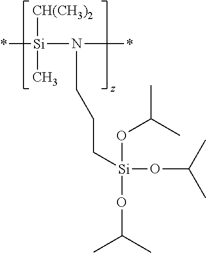 | (Ivww) |
| Isopropyl | n-Butyl | 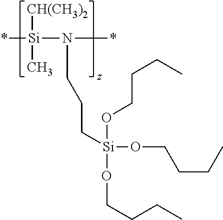 | (IVyy) |
| Isopropyl | Isobutyl | 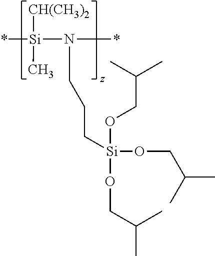 | (IVzz) |
| Isopropyl | sec-Butyl | 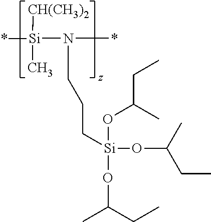 | (IVaaa) |
| Isopropyl | t-Butyl | 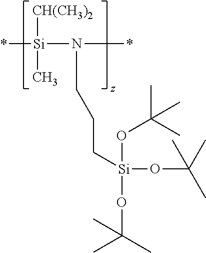 | (IVbbb) |
| n-Butyl | Methyl | 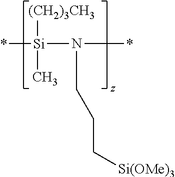 | (IVeee) |
| n-Butyl | Ethyl | 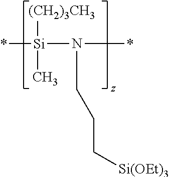 | (IVfff) |
| n-Butyl | n-Propyl | 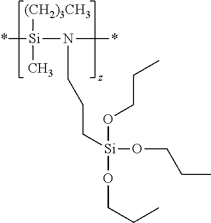 | (IVggg) |
| n-Butyl | Isopropyl | 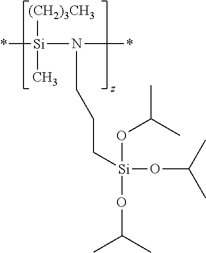 | (IVhhh) |
| n-Butyl | n-Butyl | 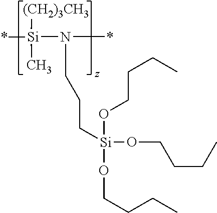 | (IVjjj) |
| n-Butyl | Isobutyl | 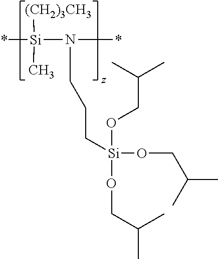 | (IVkkk) |
| n-Butyl | sec-Butyl | 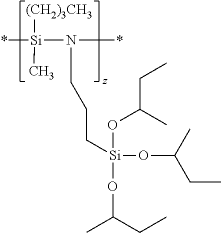 | (IVnnn) |
| n-Butyl | t-Butyl | 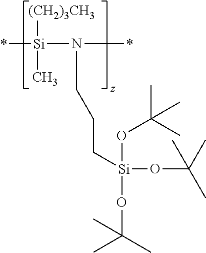 | (IVooo) |
| Isobutyl | Methyl | 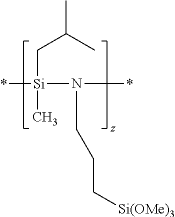 | (IVppp) |
| Isobutyl | Ethyl | 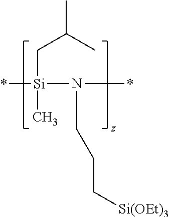 | (IVqqq) |
| Isobutyl | n-Propyl | 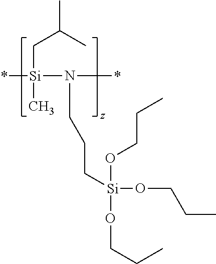 | (IVrrr) |
| Isobutyl | Isopropyl | 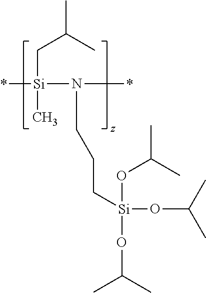 | (IVsss) |
| Isobutyl | n-Butyl | 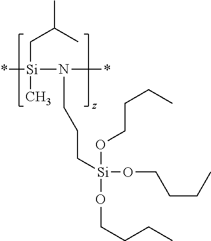 | (IVttt) |
| Isobutyl | Isobutyl | 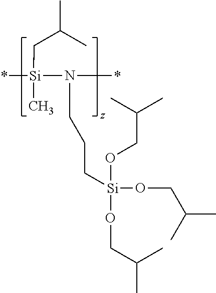 | (IVuuu) |
| Isobutyl | sec-Butyl | 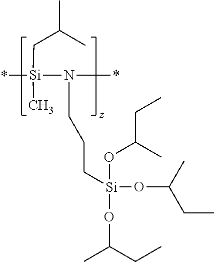 | (IVwww) |
| Isobutyl | t-Butyl | 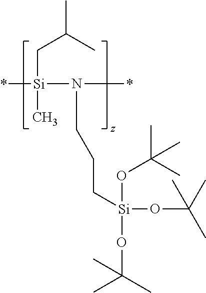 | (IVyyy) |
| sec-Butyl | Methyl | 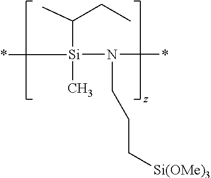 | (IVzzz) |
| sec-Butyl | Ethyl | 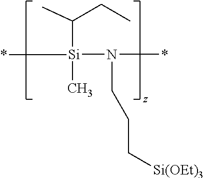 | (IVaaaa) |
| sec-Butyl | n-Propyl | 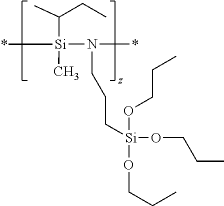 | (IVbbbb) |
| sec-Butyl | Isopropyl | 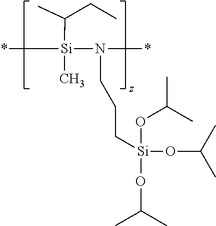 | (IVeeee) |
| sec-Butyl | n-Butyl | 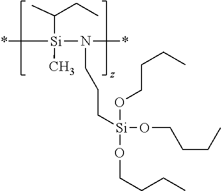 | (IVffff) |
| sec-Butyl | Isobutyl | 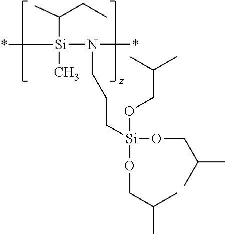 | (IVgggg) |
| sec-Butyl | sec-Butyl | 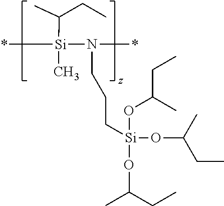 | (IVhhhh) |
| sec-Butyl | t-Butyl | 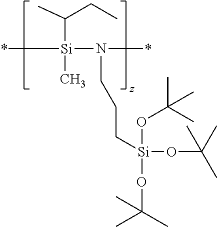 | (IVjjjj) |
| t-Butyl | Methyl | 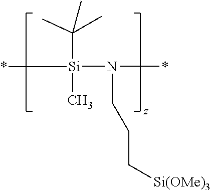 | (IVkkkk) |
| t-Butyl | Ethyl | 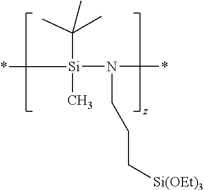 | (IVnnnn) |
| t-Butyl | n-Propyl | 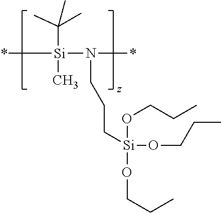 | (IVoooo) |
| t-Butyl | Isopropyl | 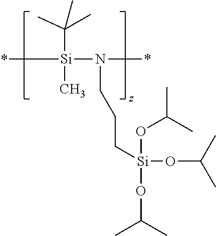 | (IVpppp) |
| t-Butyl | n-Butyl | 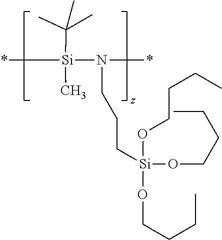 | (IVqqqq) |
| t-Butyl | Isobutyl | 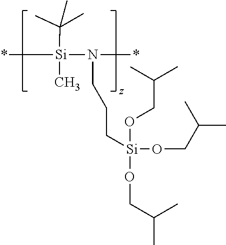 | (IVrrrr) |
| t-Butyl | sec-Butyl | 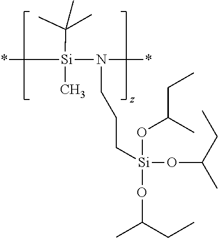 | (IVssss) |
| t-Butyl | t-Butyl | 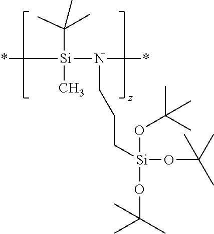 | (IVtttt) |

In some embodiments, x is about 0.5, y is about 0.25, and z is about 0.25.

In some embodiments, the PSZ having a formula consistent with general formula (III) has an average molecular weight of about 2,000 g/mol to about 3,000 g/mol, for example about 2,000 g/mol, about 2,050 g/mol, about 2,100 g/mol, about 2,150 g/mol, about 2,200 g/mol, about 2,250 g/mol, about 2,300 g/mol, about 2,350 g/mol, about 2,400 g/mol, about 2,450 g/mol, about 2,500 g/mol, about 2,550 g/mol, about 2,600 g/mol, about 2,650 g/mol, about 2,700 g/mol, about 2,750 g/mol, about 2,800 g/mol, about 2,850 g/mol, about 2,900 g/mol, about 2,950 g/mol, or about 3,000 g/mol.

The first layer 100 may have a thickness t₁₀₀ of about 1 micron to about 15 microns, about 2 microns to about 12 microns, or about 5 microns to about 10 microns. In some embodiments, the peelable layer 100 has a thickness t₁₀₀ of about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, or about 15 microns.

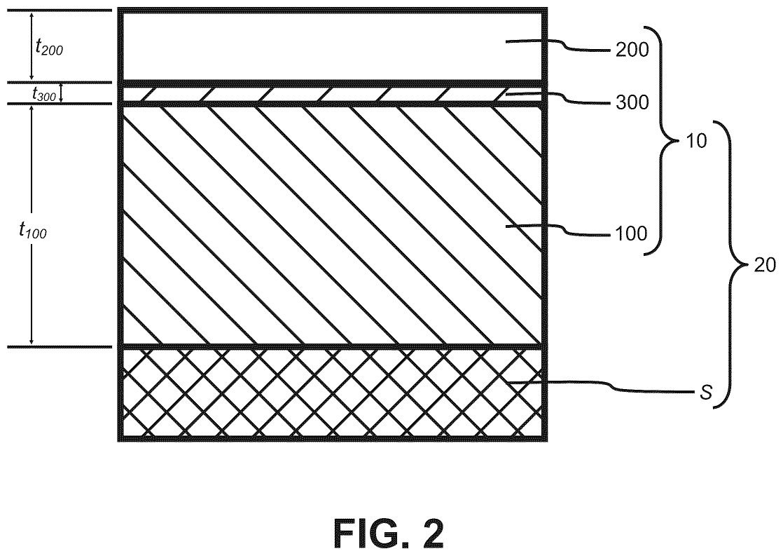

In some embodiments, the first layer 100 includes a single layer, such as shown representatively in cross-sectional format in FIGS. 1 and 2.

### B. Outer Layers

The outer layer 200 is the outermost layer of the film and is generally non-polar. The term “non-polar” as used herein refers generally to the surface properties of the outer layer 200, and indicates that the exposed surface of the non-polar layer 200 is relatively less polar (e.g., the water contact angle of the exposed surface of the non-polar layer 200 is relatively higher than the water contact angle of an exposed surface of the semi-polar layer 100). In some embodiments, the external surface of the outer layer 200 has a contact angle of about 105° to about 135° as measured by ASTM <D7334-08> (2014), or about 110° to about 125°, or about 115° to about 120°, such as about 105°, about 106°, about 107°, about 108°, about 109°, about 110°, about 111°, about 112°, about 113°, about 114°, about 115°, about 116°, about 117°, about 118°, about 119°, about 120°, about 121°, about 122°, about 123°, about 124°, about 125°, about 126°, about 127°, about 128°, about 129°, about 130°, about 131°, about 132°, about 133°, about 134°, or about 135°. In some embodiments, the non-polar layer 200 comprises a non-polar polymer. In some embodiments, the non-polar layer 200 consists essentially of a semi-polar polymer. In some embodiments, the non-polar layer 200 consists of a semi-polar polymer.

The outer layer 200 may have a thickness t₂₀₀ of about 1 micron to about 15 microns, about 3 microns to about 12 microns, or about 5 microns to about 10 microns. In some embodiments, the topcoat layer 200 has a thickness t₂₀₀ of about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, or about 15 microns.

In some embodiments, the outer layer 200 includes a single layer, such as shown representatively in cross-sectional format in FIGS. 1 and 2.

In some embodiments, the outer layer 200 comprises, consists essentially of, or consists of a polymer capable of reacting (e.g., chemically reacting) with one or more functional groups of a component of the semi-polar layer 100 (e.g., a PSZ consistent with general formula (I), with general formula (II), or with general formula (III)). In some embodiments, the resulting modified semi-polar layer 100 has a surface hydrophobicity property different from the surface hydrophobicity property of the semi-polar layer 100 before reaction with the polymer. In some embodiments, the polymer capable of reacting with a functional group of the semi-polar layer 100 includes a silanol reactive group, a carbinol reactive group, a hydride reactive group, an epoxy reactive group, an acetoxy reactive group, a chlorine reactive atom, an amine reactive group, a dimethylamine reactive group, a mercapto reactive group, an alkoxy reactive group, or a polymeric alkoxide reactive group.

In some embodiments, the outer layer 200 comprises, consists essentially of, or consists of a crosslinked terminated polydialkylsiloxane. In some embodiments, the crosslinked terminated polydialkylsiloxane is selected from the group consisting of: a crosslinked terminated polydimethylsiloxane, a crosslinked terminated polydiethylsiloxane, a crosslinked terminated polydipropylsiloxane, and a crosslinked terminated polydibutylsiloxane.

In some embodiments, the terminal groups of the crosslinked terminated polydialkylsiloxane are hydroxyl groups. In other embodiments, the terminal groups of the crosslinked terminated polydialkylsiloxane are silanol groups.

In some embodiments, the non-polar layer 100 comprises, consists essentially of, or consists of a polymer crosslinked by a methyl oximino silane crosslinking agent. In some embodiments, the oximino silane crosslinking agent is methyltris(methylethylketoxime) silane.

### C. Bridging Layers

In some embodiments, such as those generally consistent with the representative cross-sectional view shown in FIG. 2, the film 10 further includes a bridging layer 300 disposed between the first semi-polar layer 100 and the outer non-polar layer 200. When present, the bridging layer 300 may improve adhesion of the outer layer 200 to the first layer 100.

In some embodiments, the bridging layer 300 comprises, consists essentially of, or consists of a coupling agent capable of reacting (e.g., chemically reacting) with both the first semi-polar layer 100 and the outer layer 200.

The bridging layer 300 may have a thickness t₃₀₀ of about 10 microns to about 200 microns, about 20 microns to about 160 microns, about 30 microns to about 140 microns, or about 40 microns to about 100 microns. In some embodiments, the bridging layer 300 has a thickness t₃₀₀ of about 10 microns, about 15 microns, about 20 microns, about 25 microns, about 30 microns, about 35 microns, about 40 microns, about 45 microns, about 50 microns, about 55 microns, about 60 microns, about 65 microns, about 70 microns, about 75 microns, about 80 microns, about 85 microns, about 90 microns, about 95 microns, about 100 microns, about 105 microns, about 110 microns, about 115 microns, about 120 microns, about 125 microns, about 130 microns, about 135 microns, about 140 microns, about 145 microns, about 150 microns, about 155 microns, about 160 microns, about 165 microns, about 170 microns, about 175 microns, about 180 microns, about 185 microns, about 190 microns, about 195 microns, or about 200 microns.

In some embodiments, the bridging layer 300 includes a single layer, such as shown representatively in cross-sectional format in FIG. 2.

In some embodiments, the bridging layer 300 comprises, consists essentially of, or consists of an aminosilane having a general formula R″—SiX₃, wherein R″ is an organic functional group and X is a hydrolyzable group. In some embodiments, the aminosilane is a mono-functional aminosilane. In other embodiments, the aminosilane is a poly-functional aminosilane.

In some embodiments, R″ is selected from the group consisting of: hydroxy, epoxy, amino, alkoxy, and isocyanato. In some embodiments, R″ is hydroxyl. In other embodiments, R″ is epoxy. In other embodiments, R″ is amino. In other embodiments, R″ is alkoxy. In other embodiments, R″ is isocyanato.

In some embodiments, the aminosilane includes a functional group that reacts with an inorganic moiety. In some embodiments, the aminosilane includes a functional group that reacts with an organic moiety. In some embodiments, the aminosilane includes a functional group that reacts with an inorganic moiety and an organic moiety.

In some embodiments, the bridging layer 300 comprises, consists essentially of, or consists of N-[3-(trimethoxysilyl)propyl]butylamine (CAS No. 31024-56-3; also referred to as N-[3-(trimethoxysilyl)propyl]butan-1-amine, N-(n-butyl)-3 aminopropyltrimethoxysilane, Dynasylan® 1189, and Organosilane A301B), having a general formula CH₃CH₂CH₂CH₂N(H)CH₂CH₂CH₂Si(OMe)₃. In some embodiments, the bridging layer 300 comprises, consists essentially of, or consists of bis(trimethoxysilylpropyl) amine (CAS No. 82985-35-1; also referred to as bis [3-(trimethoxysilyl)propyl]amine and Dynasylan® 1124), having a general formula HN—[CH₂CH₂CH₂Si(OMe)₃]₂.

### D. Nanoparticle Layers

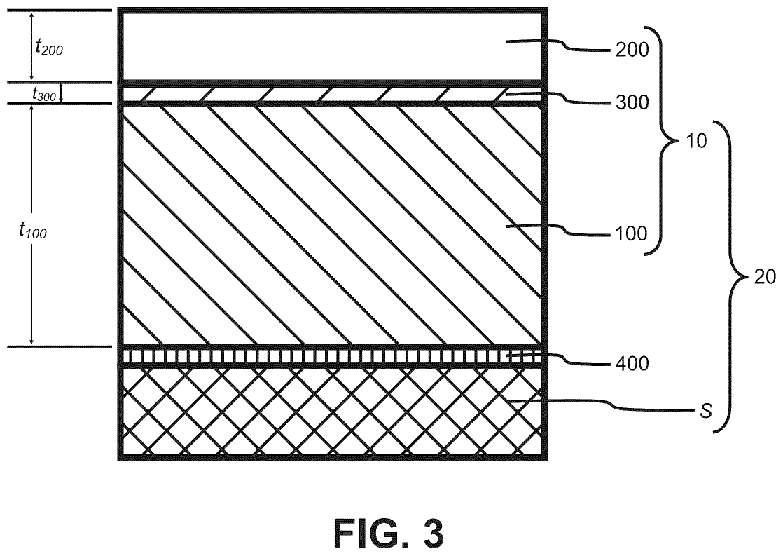

In some embodiments, such as those generally consistent with the representative cross-sectional view shown in FIG. 3, the film 10 further includes a nanoparticle layer 400 disposed between the substrate S and the first semi-polar layer 100. When present, the nanoparticle layer 400 may improve adhesion of the first semi-polar layer 100 to the substrate S.

In some embodiments, the nanoparticle layer 400 comprises, consists essentially of, or consists of a modified silica particle dispersion. For example and without limitation the modified silica particle dispersion may be an alkyl-modified (e.g., linear alkyl-modified) polydimethylsiloxane-modified silica particle dispersion. The modified silica particle dispersion may optionally have a medium polarity. The modified silica particle dispersion may optionally have an average particle size of about 15-25 nm, such as about 15 nm, about 16 nm, about 17 nm, about 18 nm, about 19 nm, about 20 nm, about 21 nm, about 22 nm, about 23 nm, about 24 nm, or about 25 nm. In some embodiments, the solid content concentration of the dispersion is about 25% to about 40%, such as 25%, about 26%, about 27%, about 28%, about 29%, about 30%, about 31%, about 32%, about 33%, about 34%, about 35%, about 36%, about 37%, about 38%, about 39%, or about 40%. The silica particle concentration of the dispersion may be about 15% to about 35%, such as about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, or about 35%.

### Film-Protected Substrates

The present disclosure also provides film-protected substrates 20 that include a film 10 disposed on at least one surface (e.g., on an outer surface, paint layer, or topcoat of the substrate S).

The substrate S may be any surface for which protection might be desired, such as a painted surface like an automobile panel. In some embodiments, the substrate S includes no paint or coating (e.g., topcoat). In other embodiments, the substrate S includes an exposed paint layer or coating, such as a clear coat or other topcoat material.

The first layer 100 is disposed on the outermost surface of the substrate S, whether that be the surface of the substrate S itself or a paint or coating layer present on the outermost surface of the substrate S. The outer layer 200 is disposed on the peelable layer 100 opposite the substrate S. Optionally (FIG. 2), a bridging layer 300 (e.g., coupling agent) is disposed between the first layer 100 and the outer layer 200.

### Methods of Forming Films

The present disclosure provides methods of forming a film 10 on a substrate S. Generally, the methods comprise a step of applying a first semi-polar layer 100 to the substrate S followed by a step of applying an outer layer 200. Optionally, the methods further include a step of applying a bridging layer 300 to the first semi-polar layer 100 before the step of applying the outer layer 200.

In some embodiments, the step of applying the first semi-polar layer 100 includes spraying a composition comprising the polymer, copolymer or block copolymer, such as a polysilazane (PSZ), a polysiloxane, or a copolymer of polysilazane and polysiloxane repeat units (e.g., a polysiloxazane) consistent with one of general formulas (I)-(III).

The semi-polar polymer composition may include, in addition to the flexible polymer or its monomeric precursors, a solvent system (i.e., one or more solvents such as heptane, xylene, and/or t-butyl acetate), and/or an antioxidant (e.g., a sterically hindered phenolic oxidant such as pentaerythritol tetrakis(3-(3,5-di-t-butyl4-hydroxyphenyl)propionate)). In some embodiments, the semi-polar polymer or its monomeric precursors are present in the composition in an amount of about 15% to about 40%, for example about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40%. In some embodiments, the composition has a viscosity at 25° C. of about 200 cps to about 300 cps, for example about 200 cps, about 205 cps, about 210 cps, about 215 cps, about 220 cps, about 225 cps, about 230 cps, about 235 cps, about 240 cps, about 245 cps, about 250 cps, about 255 cps, about 260 cps, about 265 cps, about 270 cps, about 275 cps, about 280 cps, about 285 cps, about 290 cps, about 295 cps, or about 300 cps.

In some embodiments, the step of spray-applying the first semi-polar layer 100 comprises, consists essentially of, or consists of spraying the composition comprising the polymer, copolymer or block copolymer, such as a polysilazane (PSZ), a polysiloxane, or a copolymer of polysilazane and polysiloxane repeat units (e.g., a polysiloxazane) consistent with one of general formulas (I)-(III), using a spray gun (e.g., an air-atomized spray gun, an airless spray gun, or a high-volume, low-pressure spray gun) equipped with a spray tip having a nozzle dimension of about 1.6 mm to about 2.0 mm, for example about 1.6 mm, about 1.7 mm, about 1.8 mm, about 1.9 mm, or about 2.0 mm. In some embodiments, the nozzle dimension is about 1.6 mm. In some embodiments, the nozzle dimension is about 1.7 mm. In some embodiments, the nozzle dimension is about 1.8 mm. In some embodiments, the nozzle dimension is about 1.9 mm. In some embodiments, the nozzle dimension is about 2.0 mm.

In some embodiments, the step of applying the first semi-polar layer 100 consists essentially of applying a single layer of the composition comprising the polymer, copolymer or block copolymer, such as a polysilazane (PSZ), a polysiloxane, or a copolymer of polysilazane and polysiloxane repeat units (e.g., a polysiloxazane) consistent with one of general formulas (I)-(III), to the substrate S. In other embodiments, the step of applying the first semi-polar layer 100 comprises iteratively applying multiple thin layers of the composition comprising the comprising the polymer, copolymer or block copolymer, such as a polysilazane (PSZ), a polysiloxane, or a copolymer of polysilazane and polysiloxane repeat units (e.g., a polysiloxazane) consistent with one of general formulas (I)-(III), to the substrate S. The step of applying a thin layer of the composition comprising the polymer, copolymer or block copolymer, such as a polysilazane (PSZ), a polysiloxane, or a copolymer of polysilazane and polysiloxane repeat units (e.g., a polysiloxazane) consistent with one of general formulas (I)-(III), may be repeated until the first semi-polar layer 100 has the desired thickness t₁₀₀.

The final thickness t₁₀₀ of the first semi-polar layer 100 after the step(s) of applying may be about 1 micron to about 15 microns, about 3 microns to about 12 microns, or about 5 microns to about 10 microns. In some embodiments, the final thickness t₁₀₀ of the first semi-polar layer 100 after the step(s) of applying is about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, or about 15 microns. The amount of flexible polymer composition applied to form each layer of the first semi-polar layer 100 may be selected such that each layer has a thickness of about 1 micron to about 5 microns. In some embodiments, the amount of flexible polymer composition applied to form each layer of the first semi-polar layer 100 is selected such that each layer has a thickness of about 1 micron, about 2 microns, about 3 microns, about 4 microns, or about 5 microns.

Optionally, the method further comprises applying a bridging layer 300 to the first semi-polar layer 100. When included, the step of applying the bridging layer 300 includes spraying a composition comprising a coupling agent capable of reacting (e.g., chemically reacting) with both the first semi-polar layer 100 and the outer layer 200 to the first semi-polar layer 100, for example after the semi-polar layer 100 has substantially cured or fully cured. The bridging layer composition may include, in addition to the coupling agent(s), a solvent or carrier system (i.e., one or more solvents), and/or a binder (e.g., a resin such as a lacquer, an enamel, or a urethane).

In some embodiments, the step of applying the bridging layer 300 comprises, consists essentially of, or consists of spraying the pigment composition using a spray gun (e.g., an air-atomized spray gun, an airless spray gun, or a high-volume, low-pressure spray gun) equipped with a spray tip having a nozzle dimension of about 1.0 mm to about 2.0 mm, for example about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, or about 2.0 mm. In some embodiments, the nozzle dimension is about 1.0 mm. In some embodiments, the nozzle dimension is about 1.1 mm. In some embodiments, the nozzle dimension is about 1.2 mm. In some embodiments, the nozzle dimension is about 1.3 mm. In some embodiments, the nozzle dimension is about 1.4 mm. In some embodiments, the nozzle dimension is about 1.5 mm. In some embodiments, the nozzle dimension is about 1.6 mm. In some embodiments, the nozzle dimension is about 1.7 mm. In some embodiments, the nozzle dimension is about 1.8 mm. In some embodiments, the nozzle dimension is about 1.9 mm. In some embodiments, the nozzle dimension is about 2.0 mm.

The bridging layer composition may be applied (e.g., spray-applied) until the bridging layer 300 has a desired final thickness t₃₀₀ of about 1 micron to about 10 microns, about 2 microns to about 8 microns, or about 3 microns to about 6 microns. In some embodiments, pigment composition may be applied (e.g., spray-applied) until the bridging layer 300 has a thickness t₃₀₀ of about 1 micron, about 2 microns, about 3 microns, about 4 microns, about 5 microns, about 6 microns, about 7 microns, about 8 microns, about 9 microns, or about 10 microns.

In some embodiments, the step of applying the bridging layer 300 consists essentially of applying a single layer of the coupling agent composition to the first semi-polar layer 100. In other embodiments, the step of applying the bridging layer 300 comprises applying a first layer of the coupling agent composition to the first semi-polar layer 100 followed by a step of applying a subsequent layer of the coupling agent composition to the first applied bridging layer. The step of applying the subsequent layer of the coupling agent composition may be repeated until the bridging layer 300 has the desired thickness t₃₀₀.

Methods consistent with the present disclosure further comprise a step of applying the outer layer 200 to the bridging layer 300 (when present) or to the first semi-polar layer 100 (when the bridging layer 300 is not present).

In some embodiments, the step of applying the outer layer 200 includes spraying a composition comprising the non-polar polymer, such as a crosslinked terminated polydialkylsiloxane, or its monomeric precursor(s). The non-polar polymer composition may include, in addition to the non-polar polymer or its monomeric precursor(s), a solvent system (i.e., one or more solvents such as methoxypropyl acetate). In some embodiments, the non-polar polymer has a Gardner viscosity at 25° C. of G to L (e.g., about 160 cps to about 300 cps, such as about 160 cps, about 165 cps, about 170 cps, about 175 cps, about 180 cps, about 185 cps, about 190 cps, about 195 cps, about cps, about 200 cps to about 300 cps, for example about 200 cps, about 205 cps, about 210 cps, about 215 cps, about 220 cps, about 225 cps, about 230 cps, about 235 cps, about 240 cps, about 245 cps, about 250 cps, about 255 cps, about 260 cps, about 265 cps, about 270 cps, about 275 cps, about 280 cps, about 285 cps, about 290 cps, about 295 cps, or about 300 cps).

In some embodiments, the step of spray-applying the outer layer 200 comprises, consists essentially of, or consists of spraying the non-polar polymer composition using a spray gun (e.g., an air-atomized spray gun, an airless spray gun, or a high-volume, low-pressure spray gun) equipped with a spray tip having a nozzle dimension of about 1.0 mm to about 2.0 mm, for example about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, or about 2.0 mm. In some embodiments, the nozzle dimension is about 1.0 mm. In some embodiments, the nozzle dimension is about 1.1 mm. In some embodiments, the nozzle dimension is about 1.2 mm. In some embodiments, the nozzle dimension is about 1.3 mm. In some embodiments, the nozzle dimension is about 1.4 mm. In some embodiments, the nozzle dimension is about 1.5 mm. In some embodiments, the nozzle dimension is about 1.6 mm. In some embodiments, the nozzle dimension is about 1.7 mm. In some embodiments, the nozzle dimension is about 1.8 mm. In some embodiments, the nozzle dimension is about 1.9 mm. In some embodiments, the nozzle dimension is about 2.0 mm.

In some embodiments, the step of applying the outer layer 200 consists essentially of applying a single layer of the non-polar polymer composition to the bridging layer 300 (when present) or to the first semi-polar layer 100. In other embodiments, the step of applying the outer layer 200 comprises applying a first layer of the non-polar polymer composition to the bridging layer 300 or to the first semi-polar layer 100, followed by a step of applying a subsequent layer of the non-polar polymer composition to the first applied layer of the non-polar polymer composition. The step of applying the subsequent layer of the non-polar polymer composition may be repeated until the outer layer 200 has the desired thickness t₂₀₀.

The final thickness t₂₀₀ of the topcoat layer 200 after the step(s) of applying may be about 1 micron to about 15 microns, about 2 microns to about 12 microns, or about 5 microns to about 10 microns. In some embodiments, the final thickness t₂₀₀ of the topcoat layer 200 after the step(s) of applying is about 1 micron, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, or about 15 microns. The amount of self-healing polymer composition applied to form each layer of the topcoat layer 200 may be selected such that each layer has a thickness of about 1 micron to about 3 microns.

In other embodiments, a method consistent with the present disclosure comprises, consists essentially of, or consists of applying in a single step a composition comprising (a) the semi-polar polymer or its monomeric precursor(s) that forms, upon curing, the first semi-polar layer 100; and (b) the non-polar polymer or its monomeric precursor(s) that forms, upon curing, the outer layer 200.

In other embodiments, a method consistent with the present disclosure comprises, consists essentially of, or consists of applying in a single step a composition comprising (a) the semi-polar polymer or its monomeric precursor(s) that forms, upon curing, the first semi-polar layer 100; (b) the non-polar polymer or its monomeric precursor(s) that forms, upon curing, the outer layer 200; and (c) the coupling agent that, upon curing, forms the bridging layer 300.

In other embodiments, a method consistent with the present disclosure comprises, consists essentially of, or consists of applying in a single step a composition comprising (a) the semi-polar polymer or its monomeric precursor(s) that forms, upon curing, the first semi-polar layer 100; (b) the non-polar polymer or its monomeric precursor(s) that forms, upon curing, the outer layer 200; (c) the coupling agent that, upon curing, forms the bridging layer 300; and (d) the nanoparticle material that, upon curing, is disposed between the substrate S and the first semi-polar layer 100.

1: A protective film comprising:
a first layer disposed adjacent to a painted surface, the first layer comprising, consisting essentially of, or consisting of a semi-polar polymer; and
an outer layer disposed opposite the painted surface, the outer layer comprising, consisting essentially of, or consisting of a non-polar material.

2: The protective film of claim 1, wherein the semi-polar polymer comprises, consists essentially of, or consists of a polymer, a copolymer or block copolymer.

3: The protective film of claim 1, wherein the semi-polar polymer comprises, consists essentially of, or consists of a polysilazane (PSZ), a perhydropolysilazane (PHPS) or a copolymer of polysilazane and other nitrogen containing polymers, oligomers or monomers, including urethane, isocyanate, isocyanato, polyurea, polyamine, as well as hydrophilic modification by protic polymers, oligomers and monomers like cationic salts and hydrophilic silanes.

4: The protective film of claim 1, wherein the semi-polar polymer comprises, consists essentially of, or consists of a PSZ having a formula consistent with general formula (I): 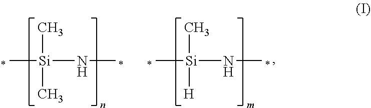
wherein:
m is 0.5 to 0.9,
n is 0.1 to 0.5, and
m+n=1.

5: The protective film of claim 1, wherein the semi-polar polymer comprises, consists essentially of, or consists of a PSZ having a formula consistent with general formula (II): 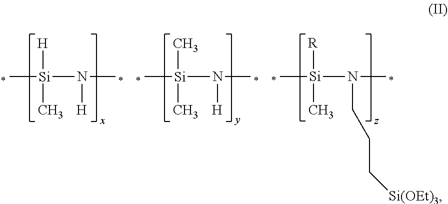
wherein:
x is 0.45 to 0.59,
y is 0.22 to 0.29,
z is 0.12 to 0.33,
x+y+z is 1, and
R is H or CH₃.

6: The protective film of claim 5, wherein x is about 0.5, y is about 0.25, and z is about 0.25.

7: The protective film of claim 1, wherein the semi-polar polymer comprises, consists essentially of, or consists of a PSZ having a formula consistent with general formula (III): 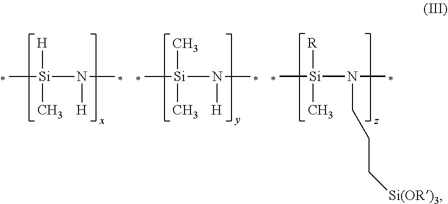
wherein:
x is 0.3 to 0.7,
y is 0.1 to 0.4,
z is 0.05 to 0.5,
x+y+z is 1,
R is H, Me, Et, n-Pr, i-Pr, n-Bu, i-Bu, sec-Bu, or t-Bu, and
R′ is Me, Et, n-Pr, i-Pr, n-Bu, i-Bu, sec-Bu, or t-Bu.

8: The protective film of claim 7, wherein x is about 0.5, y is about 0.25, and z is about 0.25.

9: The protective film of claim 3, wherein the PSZ has an average molecular weight of about 2,000 g/mol to about 3,000 g/mol.

10: The protective film of claim 1, wherein the non-polar material comprises, consists essentially of, or consists of a crosslinked terminated polydialkylsiloxane.

11: The protective film of claim 3, wherein the non-polar material comprises, consists essentially of, or consists of a polymer configured to react with the PSZ to modify a surface hydrophobicity property of the PSZ.

12: The protective film of claim 11, wherein the PSZ reacts with a silanol, carbinol, hydride, epoxy, acetoxy, chlorine, amine, dimethylamine, mercapto, alkoxy, or polymeric alkoxide functional group of the polymer.

13: The protective film of claim 10, wherein the non-polar material is a crosslinked hydroxy-terminated polydialkylsiloxane.

14: The protective film of claim 11, wherein the non-polar material is a crosslinked hydroxy-terminated polydimethylsiloxane.

15: The protective film of claim 10, wherein the non-polar material is a crosslinked silanol-terminated polydialkylsiloxane.

16: The protective film of claim 15, wherein the non-polar material is a crosslinked silanol-terminated polydimethylsiloxane.

17: The protective film of claim 10, wherein the non-polar material is crosslinked by a methyl oximino silane crosslinking agent.

18: The protective film of claim 17, wherein the oximino silane crosslinking agent is methyltris(methylethylketoxime) silane.

19: The protective film of claim 1 further comprising a coupling agent that forms a bridging layer between the first layer and the outer layer.

20: The protective film of claim 19, wherein the bridging layer comprises, consists essentially of, or consists of an aminosilane of the form, R″—SiX₃, wherein R″ is an organic functional group and X is a hydrolyzable group.

21. (canceled)

22: The protective film of claim 20, wherein the aminosilane is a mono-functional amine or a poly-functional aminosilane.

23: The protective film of claim 22, wherein the aminosilane has a functional group selected from the group consisting of: hydroxy, epoxy, amino, alkoxy, and isocyanato.

24: The protective film of claim 22, wherein the poly-functional aminosilane has a functional group that reacts with an inorganic moiety and/or an organic moiety.

25: The protective film of claim 19, wherein the bridging layer comprises, consists essentially of, or consists of one or more silane selected from the group consisting of: N-[3-(trimethoxysilyl)propyl]butylamine (CAS No. 31024-56-3; also referred to as N-(n-butyl)-3 aminopropyltrimethoxysilane, Dynasylan® 1189, and Organosilane A301B), and bis(trimethoxysilylpropyl) amine (CAS No. 82985-35-1; also referred to as Dynasylan® 1124).

26-55. (canceled)
